(19) United States
(12) Patent Application Publication
(10) Pub. No.: US 2008/0147520 A1
(43) Pub. Date: Jun. 19, 2008

(54) Method and apparatus for providing electronic inventory service

(75) Inventor: Moon-sang Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/790,119

(22) Filed: Apr. 24, 2007

(30) Foreign Application Priority Data
Dec. 18, 2006 (KR) 10-2006-0129683

(51) Int. Cl. G06Q 10/00

(52) U.S. Cl. 705/28

(57) ABSTRACT

Provided are a method and apparatus for providing an electronic inventory service. An electronic inventory service providing apparatus includes a storage unit which stores product information regarding at least one product; and a control unit which executes at least one service application using the product information, wherein the product information includes product ID information to identify the product. Services can be provided for every product without restriction to users by storing information regarding products that the users use and using the stored information.

### CROSS-REFERENCE TO RELATED PATENT APPLICATION

This application claims priority from Korean Patent Application No. 10-2006-0129683, filed on Dec. 18, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to storing product information and using the information, and more particularly, to providing an electronic inventory service in order to store information regarding products which users use and provide services using the product information.

2. Description of the Related Art

Related art home network technology enables the control of main household appliances such as refrigerators, air-conditioners, microwave ovens and television sets by using wired or wireless Internet and the sharing of contents between the appliances. When a home network is set up, household appliances can be controlled by a portable terminal inside or outside the house. Also, Internet connection, motion picture transfer, and e-mail communication are enabled through the household appliances inside or outside the house.

The related art Universal Plug and Play (UPnP) standard, which can be used in a home network, enables devices such as personal computers (PCs), peripheral devices, artificially intelligent household appliances and wireless devices to automatically recognize each other using Internet and web protocols when the devices are connected to a network. However, UPnP technology enables only mutual operation between electric devices that are turned on and connected to the network. The UPnP technology cannot be applied to devices that are turned off, or to non-electric products. Since UPnP technology is applied only to devices connected to a network, it is focused on mutual-operations such as monitoring and controlling between the devices. Accordingly, the number of products whose information can be provided to users through the Internet and home networks is limited, and applicable functions using the information are also limited.

### SUMMARY OF THE INVENTION

The present invention provides a method and apparatus for providing an electronic inventory service in order to store product information regarding products which users use and provide various services available on a network using the product information.

According to an aspect of the present invention, there is provided an electronic inventory service providing apparatus including a storage unit which stores product information regarding at least one product; and a control unit which executes at least one service application using the product information, wherein the product information comprises product identification (ID) information to identify the product that a user uses.

According to another aspect of the present invention, there is provided a method of providing an electronic inventory service, the method including storing product information regarding at least one product; and executing at least one service application using the product information, wherein the product information comprises product ID information to identify the product that a user uses.

According to another aspect of the present invention, there is provided a computer readable recording medium having embodied thereon a computer program for executing a method of providing an electronic inventory service, the method including storing product information regarding at least one product; and executing at least one service application using the product information, wherein the product information comprises product ID information to identify the product that a user uses.

### BRIEF DESCRIPTION OF THE DRAWINGS

The above and other aspects of the present invention will become more apparent by describing in detail exemplary embodiments thereof with reference to the attached drawings in which:

FIG. 1 illustrates an electronic inventory service providing system including an electronic inventory service providing apparatus according to an exemplary embodiment of the present invention;

FIG. 2 is a block diagram of the electronic inventory service providing apparatus of FIG. 1 according to an exemplary embodiment of the present invention;

FIG. 3 is a flowchart of a method of providing an electronic inventory service according to an exemplary embodiment of the present invention;

FIG. 4 is a flowchart of a method of providing an electronic inventory service according to another exemplary embodiment of the present invention;

FIG. 5 is a flowchart of a method of providing an electronic inventory service according to another exemplary embodiment of the present invention;

FIG. 6 is a flowchart of a method of providing an electronic inventory service according to another exemplary embodiment of the present invention;

FIG. 7 is a flowchart of a method of providing an electronic inventory service according to another exemplary embodiment of the present invention; and

FIG. 8 is a flowchart of a method of providing an electronic inventory service according to another exemplary embodiment of the present invention.

### DETAILED DESCRIPTION OF THE EXEMPLARY EMBODIMENTS

Hereinafter, the present invention will be described in detail by explaining exemplary embodiments of the invention with reference to the attached drawings.

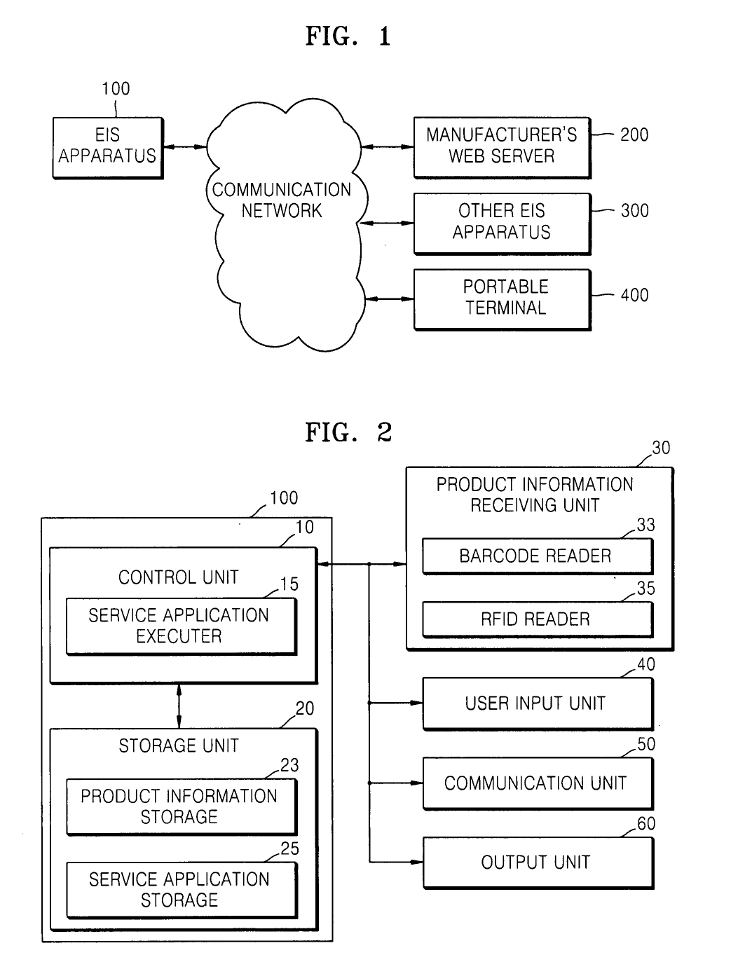

FIG. 1 illustrates an electronic inventory service providing system including an electronic inventory service providing apparatus according to an exemplary embodiment of the present invention.

The electronic inventory service providing apparatus, referred to as an electronic inventory service (EIS) apparatus 100, may be composed of a home server coupled to a communication network such as a home network or the Internet. The communication network may be a wired or wireless communication network through which product information can be transferred.

The EIS apparatus 100 stores product information regarding products which a user has purchased or possesses, and provides an inventory service with regard to the product information. The user is a client who uses a product by purchasing the product. The product information stored in the EIS apparatus 100 includes product information regarding the products that the user has purchased or possesses including but not limited to books, clothes, bags, cars, as well as household appliances such as television sets, blu-ray disc (BD)/high-definition (HD) digital versatile disc (DVD) players, washing machines, microwave ovens, audio players and personal computers (PCs).

The product information includes product ID information for identifying each individual product. The product ID information may include various pieces of information regarding the product such as manufacturer, manufacturing date, model name, serial number and manufacturer's web server address; however, the exemplary embodiment is not limited thereto, and other information as would be understood by one skilled in the art may be provided. The product ID information may have a variety of forms as long as the product ID information clearly identifies the individual product that the user uses.

The EIS apparatus 100 may provide various inventory services to the user by storing the product information regarding the products that the user uses. For example, the EIS apparatus 100 may obtain additional information regarding the product using the product information by connecting to a manufacturer's web server 200. Additionally, the EIS apparatus 100 may connect to another EIS apparatus 300 and then obtain product information regarding products, which both the EIS apparatus 100 and EIS apparatus 300 have in common, by using a peer to peer (P2P) method. Further, if the user needs information regarding at least one of their products while the user is not at home but has a portable terminal 400, the user can connect with the EIS apparatus 100 by using the portable terminal 400, thereby obtaining information regarding the product.

FIG. 2 is a block diagram of the EIS apparatus 100 of FIG. 1 according to an exemplary embodiment of the present invention. The EIS apparatus 100 includes a control unit 10 and a storage unit 20.

The control unit 10 executes at least one service application which uses the product information stored in the EIS apparatus 100. For the execution of the service application, the control unit 10 provides an environment in which the service application is executed and includes a service application executer 15 in order to execute program codes included in the service application. The service application may be provided using information regarding the products that the user uses. At least one service application is included according to the purpose of the service provided.

The service application may be executed according to a user input signal which requests a service to be provided. Otherwise, the service application may be executed if preset conditions are met.

For example, if the product information includes state information about whether the product operates normally and the state information indicates that an error has occurred in the product, a service application which provides after-service (A/S) information may be executed. Otherwise, if data based on the product information is received from an external web server using a protocol such as really simple syndication (RSS), a service application which provides the data to the user can be executed.

The service application may be a web application for providing a web service, or may be executed together with a web application. Also, the service application provides data regarding the product to the user through a communication network from an external server, and can be received from the external server and stored.

The storage unit 20 stores product information regarding at least one product. The storage unit 20 may include a product information storage unit 23 which stores the product information, and a service application storage unit 25 which stores the service application executed in the control unit 10.

To receive additional information regarding the product stored in the product information storage unit 23 or information regarding other products, a product information receiving unit 30 can be further included. The control unit 10 stores the product information received from the product information receiving unit 30 in the storage unit 20. The product information includes the product ID information, but is not limited thereto. The product information receiving unit 30 may receive the product information by reading product information attached to a product to identify the product.

For example, the product ID information may be a barcode or an electronic product code (EPC). The EPC may be input to and stored in a radio frequency identification (RFID) tag. The EPC identifies individual products, and can identify all the products with the same barcodes separately.

The product information receiving unit 30 includes a module to read the product ID information. The product information receiving unit 30 may include, for example, a barcode reader 33 which reads the a barcode on a product and an RFID tag reader 35 which reads the RFID tag. Also, the product information receiving unit 30 may include a module (not shown) which performs UPnP functions such that, if the product used by the user is a UPnP device, the product information receiving unit 30 substantially automatically recognizes the product information of the UPnP device.

A user input unit 40 receives a user input signal. When the user input signal for inputting product information such as text data is received, the control unit 10 stores the input product information in the product information storage 23 in the substantially same manner as the product information received through the product information receiving unit 30.

The EIS apparatus 100 may further include a communication unit 50 which controls a connection with a communication network so as to execute a service application which performs data communication through a home network or the Internet.

An output unit 60 outputs a result of the execution of the service application using the product information. According to an exemplary embodiment, when the user input unit 40 receives the user input signal which requests the product information, the control unit 10 may execute an application which forms a screen to provide information on the product that the user requested and outputs the result to the output unit 60.

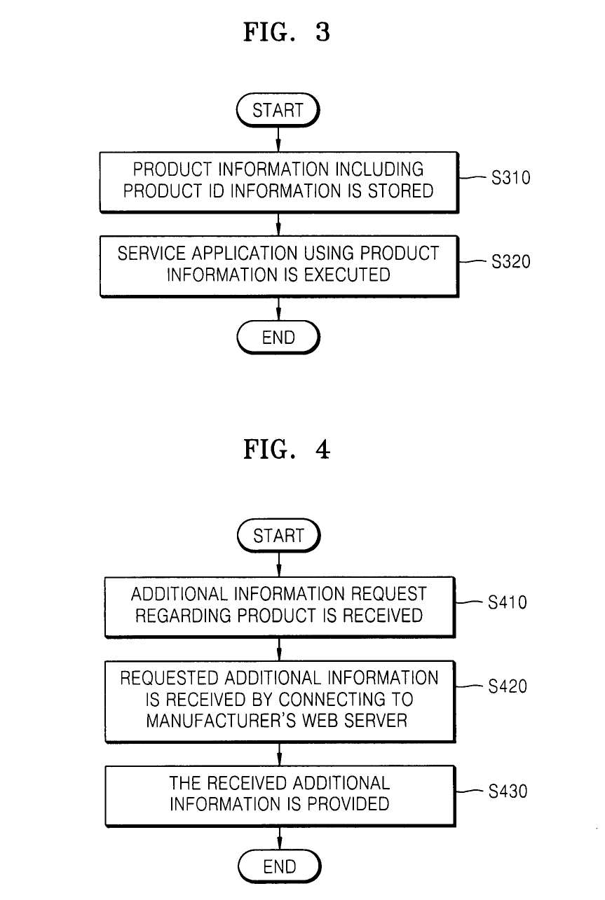

FIG. 3 is a flowchart of a method of providing an electronic inventory service according to an exemplary embodiment of the present invention.

In operation S310, product information regarding at least one product is stored. Inventory is generated by the stored product information. The product information includes product ID information to identify the product that a user uses.

In operation S320, at least one service application which uses the product information is executed. The service applications can be executed according to a user input signal or when at least one condition is met.

FIG. 4 is a flowchart of a method of providing an electronic inventory service according to another exemplary embodiment of the present invention. The flowchart of FIG. 4 will be described in conjunction with the system of FIG. 1 and the apparatus of FIG. 2.

In operation S410, when the user input unit 40 receives a user input signal which requests information regarding a product, the control unit 10 executes a service application which provides the additional information regarding the product based on the user input signal.

According to the execution of the service application, in operation S420, the control unit 10 requests the additional information regarding the product by connecting to the manufacturer's web server 200 through the communication unit 50 and then receives the additional information. When the manufacturer's web server 200 is requested to provide the additional information regarding the product, product ID information required by a user is transferred so that the manufacturer's web server 200 may transmit the additional information regarding the product identified by the product ID information.

In operation S430, the control unit 10 provides the additional information received from the manufacturer's web server 200 to the user through an output unit 60.

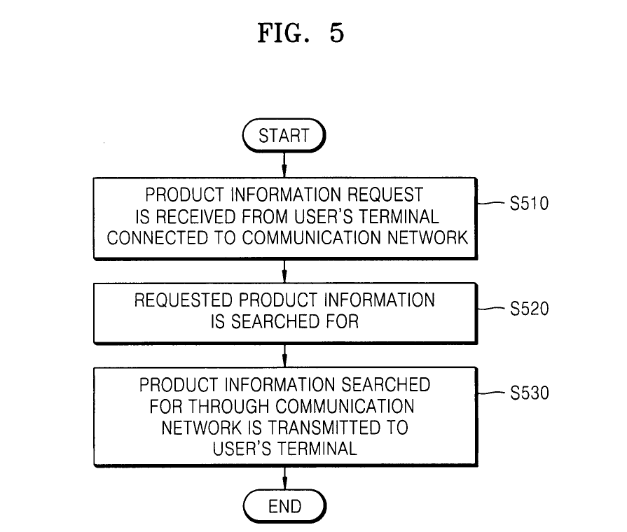

FIG. 5 is a flowchart of a method of providing an electronic inventory service according to another exemplary embodiment of the present invention. The flowchart of FIG. 5 will be described in conjunction with the system of FIG. 1 and the apparatus of FIG. 2.

In operation S510, when the EIS apparatus 100′ receives a product information request signal from the user's portable terminal 400 which is connected to a communication network, the control unit 10 may execute a service application to transmit product information to the portable terminal 400. The product information request signal may include a message which requests the product information regarding one or more products.

According to the execution of the service application, in operation S520, the control unit 10 searches for the product information stored in the storage unit 20, regarding the requested product based on the request signal. In operation S530, the control unit 10 controls the communication unit 50 so as to transmit the searched for product information to the portable terminal 400. This type of service may be used, for example but not by way of limitation, when the user wants to know a model name of a product and is not in a substantially close communication range (e.g., away from home).

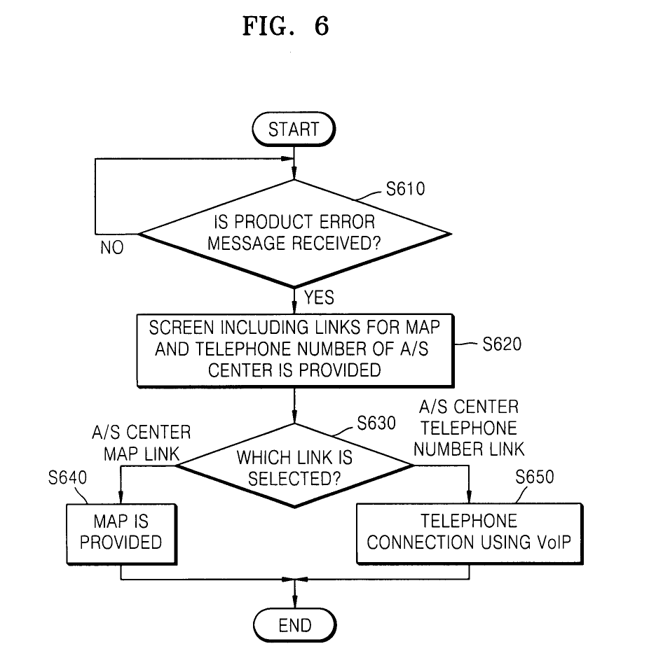

FIG. 6 is a flowchart of a method of providing an electronic inventory service according to another exemplary embodiment. The flowchart of FIG. 6 will be described in conjunction with the apparatus of FIG. 2.

In operation S610, if a product such as an electronic device is broken, the control unit 10 executes a service application which provides an informing service for after-sales service (A/S) of the product.

According to the execution of the service application, in operation S620, the control unit 10 provides a screen including links for a map and a telephone number of an A/S center for the product to an output unit 60.

In operation S630, a user input signal which selects a link is received through the user input unit 40. If the user input signal has selected a link to provide a map of the closest A/S center from the user, in operation S640, the map of the A/S center is searched for in the storage unit 20 or in an external web server and provided to the user. If the user input signal has selected a link to provide a telephone number of the A/S center, in operation S650, a telephone connection to the closest A/S center may be provided using, for example but not by way of limitation, a voice over Internet protocol (VoIP). However, other communication protocols as would be understood by one skilled in the art at the time of the invention may be substituted therefore without departing from the scope of the invention.

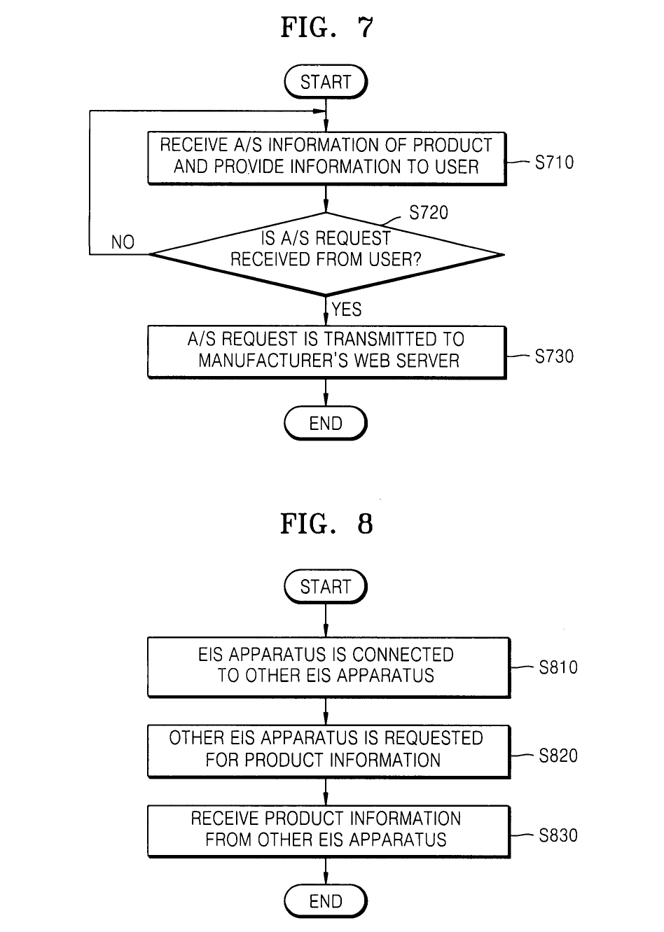

FIG. 7 is a flowchart of a method of providing an electronic inventory service according to another exemplary embodiment of the present invention. The flowchart of FIG. 7 will be described in conjunction with the system of FIG. 1 and the apparatus of FIG. 2.

If product A/S information such as a recall announcement is received from an external web server in an RSS service, in operation S710, the control unit 10 may identify a product corresponding to the product A/S information and then execute a service application which easily requests A/S for the product, which is managed by the product's manufacturer.

According to the execution of the service application, in operation S720, if a user input signal, which requests A/S, is received from the user input unit 40, in operation S730, the control unit 10 controls the communication unit 50 and transmits an A/S request message and product information to the manufacturer's web server 200 and thereby the manufacturer can perform A/S for the product.

This type of service can be applied for a variety of occasions, for example, if an information providing server such as a manufacturer has to provide a patch program to the products, if a recall announcement has to be made to the purchasers, if a new manual has to be distributed, or if recommended information such as a target advertisement indicating when a new product which can be used with the purchased product comes into the market, has to be provided to users.

FIG. 8 is a flowchart of a method of providing an electronic inventory service according to another exemplary embodiment of the present invention. The flowchart of FIG. 8 will be described in conjunction with the system of FIG. 1 and the apparatus of FIG. 2.

If a service application which provides P2P service between EIS apparatuses is executed, in operation S810, the EIS apparatus 100 controls the communication unit 50 so as to connect to the other EIS apparatus 300.

In operation S820, the EIS apparatus 100 requests the other EIS apparatus 300 for product information. In operation S830, the product information is received from the other EIS apparatus 300. By performing this kind of service, communities for each product or each product category can be formed and thereby the product information may be exchanged.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and flash memory. The computer readable recording medium can also be distributed over network coupled computer systems so that the computer readable code is stored and executed in a distributed fashion.

As described above, various services can be provided for every product without restriction to users by storing information regarding products that the users use and using the stored information. Also, the users can search for information regarding the products they have while they are away from home and various services which can be provided based on the product information are provided to the users through the communication network.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An electronic inventory service providing apparatus comprising:
a storage unit which stores product information regarding at least one product; and
a control unit which executes at least one service application using the product information,
wherein the product information comprises product identification (ID) information indicative of the at least one product.

2. The electronic inventory service providing apparatus of claim 1, further comprising a communication unit which controls a connection with a communication network,
wherein the at least one service application includes an application executed by transmitting and receiving data through one of a home network and the Internet.

3. The electronic inventory service providing apparatus of claim 1, further comprising a product information receiving unit which receives the product information,
wherein the control unit stores the received product information in the storage unit.

4. The electronic inventory service providing apparatus of claim 3, wherein the product information receiving unit reads product identifying codes which are attached to the at least one product.

5. The electronic inventory service providing apparatus of claim 3, wherein, if the product is a Universal Plug and Play (UPnP) device, the product information receiving unit recognizes the product ID information of the UPnP device.

6. The electronic inventory service providing apparatus of claim 3, further comprising a user input unit which receives a user input signal,
wherein the product information receiving unit receives product information input through the user input unit.

7. The electronic inventory service providing apparatus of claim 1, wherein the product information comprises of a barcode and an electronic product codes (EPC).

8. The electronic inventory service providing apparatus of claim 1, further comprising an output unit which outputs an execution result of the service application.

9. The electronic inventory service providing apparatus of claim 1, wherein, if a user input signal which requests additional information regarding the at least one product is received, the control unit executes a services application which receives the additional information regarding the at least one product from a web server and provides the additional information to the user.

10. The electronic inventory service providing apparatus of claim 1, wherein, if a product information request signal is received from a terminal connected to a communication network, the control unit executes a service application which transmits the product information stored in the storage unit to the terminal.

11. The electronic inventory service providing apparatus of claim 1, wherein the control unit executes a service application to receive at least one of after-sales service (A/S) information, a recall announcement, a manual, a patch program and information about another product from a web server.

12. The electronic inventory service providing apparatus of claim 1, wherein the control unit, which executes a service application, connects to another electronic inventory service providing apparatus by controlling a communication unit and receives product information stored in the other electronic inventory service providing apparatus from the other electronic inventory service providing apparatus.

13. A method of providing an electronic inventory service, the method comprising:
storing product information regarding at least one product; and
executing at least one service application using the product information,
wherein the product information comprises product identification (ID) information indicative of the at least one product.

14. The method of providing the electronic inventory service of claim 13, further comprising receiving the product information regarding the at least one product.

15. The method of providing the electronic inventory service of claim 14, wherein the receiving of the product information comprises receiving the product information by reading product identifying codes of the at least one product.

16. The method of providing the electronic inventory service of claim 14, wherein, if the at least one product is a Universal Plug and Play (UPnP) device, the receiving of the product information comprises recognizing the product ID information of the UPnP device.

17. The method of providing the electronic inventory service of claim 14, wherein the product information is received by a user input signal.

18. The method of providing the electronic inventory service of claim 13, wherein the product information comprises at least one of a barcode and an electronic product code (EPC).

19. The method of providing the electronic inventory service of claim 13, the method further comprising outputting an execution result of the service application.

20. The method of providing the electronic inventory service of claim 13, wherein the executing of at least one service application using the product information comprises:
receiving a user input signal which requests additional information regarding the at least one product;
requesting a web server for the additional information regarding the at least one product; and
receiving the additional information from the web server and providing the additional information to the user.

21. The method of providing the electronic inventory service of claim 13, wherein the executing of at least one service application using the product information comprises, if a electronic inventory service providing apparatus receives a product information request signal from a terminal connected to communication network, transmitting the stored product information to the terminal.

22. The method of providing the electronic inventory service of claim 13, wherein the executing of at least one service application using the product information comprises receiving at least one of A/S information, a recall announcement, a manual, a patch program and recommended information on another product from a web server.

23. The method of providing the electronic inventory service of claim 13, wherein the executing of at least one service application using the product information comprises:
connecting to another electronic inventory service providing apparatus; and
receiving product information stored in the other electronic inventory service providing apparatus from the other electronic inventory service providing apparatus.

24. A computer readable recording medium having embodied thereon a computer program for executing a method of providing an electronic inventory service, the method comprising:
storing product information regarding at least one product; and
executing at least one service application using the product information,
wherein the product information comprises product identification (ID) information indicative of the at least one product.
